(19) United States
(12) Patent Application Publication
(10) Pub. No.: US 2009/0027879 A1
(43) Pub. Date: Jan. 29, 2009

(54) Light emitting stick

(76) Inventor: Li-Chen Wang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,469

(22) Filed: Jul. 25, 2007

(51) Int. Cl. F21S 4/00

(52) U.S. Cl. 362/223

(57) ABSTRACT

The present invention relates to a light emitting stick which has a light transmissible stick body. One end of the stick body is an insertion end which is combined with a light emitting element (light emitting diode) coated with optical adhesive (UV adhesive). A plurality of recesses with matte finish is formed on the outside surface of the light transmissible stick body by etching. According to this structure, the light emitted by the light emitting element is transmitted through the optical adhesive without distortion, so that brighter luminescence can be obtained after the reflection conducted within the stick body. Therefore, better entertainment effect can be achieved by the light emitting stick.

### BACKGROUND OF THE INVENTION

1. Field of the Invention

The present invention relates to a light emitting stick, more particularly to a stick body enabling light emission that is adapted to add the fun in entertainment or activities, wherein the light emitted from a light emitting element inserted into one end of a light transmissible stick body having recesses with matte finish on the outer surface is transmitted without distortion, so that entertainment effect with brighter luminescence can be achieved by the light emitting stick.

2. Brief Description of the Prior Art

Concerning the leisure arrangement in holiday or at night time for ordinary people, young generation would prefer to attend party, concert performance or sport contest such as baseball game. In order to enhance the buildup of pleasant and thrilling atmosphere in activity at night time, objects to make activity more lively such as glow stick, light emitting stick, whistle, percussion bar, air horn etc. are substantially utilized to bustle with sound and light in activities. Glow sticks are mostly welcomed to be used in night time activities as the means to generate light. The glow stick is formed by a plastic tube having a green liquid inside and a small glass tube having white liquid therein. A certain kind of dye and a derivative of Diacetyl Cabbages Acid (DCA) and a glass vial are contained in the plastic tube. The chemical substance sealed inside the glass vial is hydrogen peroxide solved in the solvent of phthalate ester. When in use, the glow stick is bent slightly to make the glass vial break and is shaken in up-down direction such that the hydrogen peroxide reacts with the other chemicals to emit light. However, these chemical substances are toxic to some extent, careless contact with these chemical substances would cause hazard.

In view of the above defect, some light emitting sticks containing light emitting diode (LED) as the key part are developed. As the person skilled in the art understands that the light beam emitted from the LED is not that bright and the light beam is a direct light. Therefore, a number of LEDs have to be assembled in the light emitting stick, so this will result in higher cost. The property of direct light only enables the people aligned with the stick body head to see the light, the other place except the stick body head has no light. Thus, this light emitting stick is unsatisfactory in use and is in lack of recreational effect.

In view of the defect inherent in the application of the above light emitting stick, the inventor of this invention thus undergoes the research and improvement with respect to the conventional light emitting stick with a mind and spirit in pursuit of excellence based on the professional knowledge and experience accumulated in the long term involvement of relevant field, and eventually proposes a novel light emitting stick after repeated pondering and experiments.

### SUMMARY OF THE INVENTION

The object of the present invention is to provide a light emitting stick in which the scattering of light is not hindered based on the principle of reflection in cooperation with the coating of a adhesive having light guide effect, such that the light emitted from the LED has better light transmissible effect.

In order to realize the above object, a light emitting stick of the present invention is provided, wherein the light emitting stick of the present invention has a light transmissible stick body, one end of the stick body being an insertion end that is combined with a light emitting element (light emitting diode) coated with optical adhesive (UV adhesive), and a plurality of recesses with matte finish being formed on the outside surface of the light transmissible stick body by etching. According to this structure, the light emitted by the light emitting element is transmitted through the optical adhesive without any distortion, so that brighter luminescence can be obtained after the reflection conducted within the stick body. Therefore, better entertainment effect can be achieved by the light emitting stick.

### BRIEF DESCRIPTION OF THE ACCOMPANYING DRAWINGS

The present invention will be better understood by the detailed description of the preferred embodiments with reference to the accompanying drawings, in which:

FIG. 1 is a schematic perspective exploded view showing the first embodiment of the present invention.

FIG. 2 is a schematic sectional view showing the first embodiment of the present invention.

FIG. 3 is a schematic perspective view showing the appearance of the second embodiment of the present invention.

FIG. 4 is a schematic partial exploded view of the present invention.

FIG. 5 is a schematic sectional view showing the third embodiment of the present invention.

FIG. 6 is a schematic sectional view showing the fourth embodiment of the present invention.

FIG. 7 is a schematic perspective exploded view showing the fifth embodiment of the present invention.

FIG. 8 is a schematic sectional view showing the fifth embodiment of the present invention.

FIG. 9 is a schematic perspective exploded view showing the sixth embodiment of the present invention.

### DETAILED DESCRIPTION OF THE PREFERRED EMBODIMENTS

The technical content, objects and effectiveness of the present invention will become more apparent by the detailed description of the following preferred embodiments of the present invention with reference to the accompanying drawings.

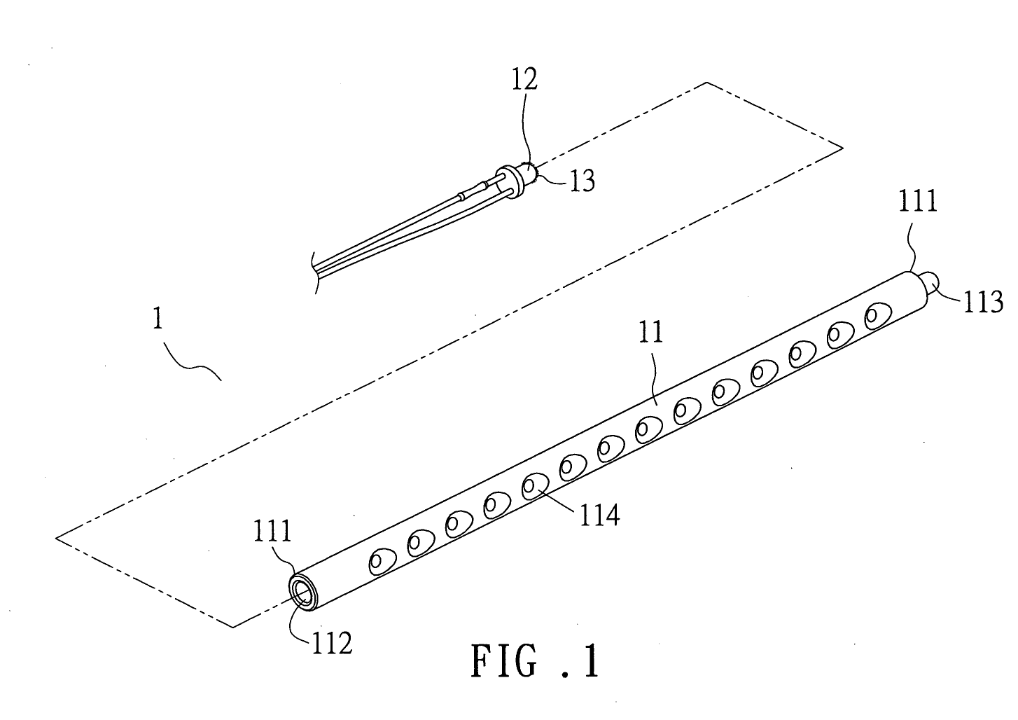

FIG. 1 is a schematic perspective exploded view showing the first embodiment of the present invention. In FIG. 1, the light emitting stick (1) has a light transmissible stick body (11), one end of the light transmissible stick body (11) being an insertion end (111) that is inserted and combined with a light emitting element (12) coated with optical adhesive (13), and a plurality of recesses (114) with matte finish being arranged on the outside surface of the light transmissible stick body (11) by etching.

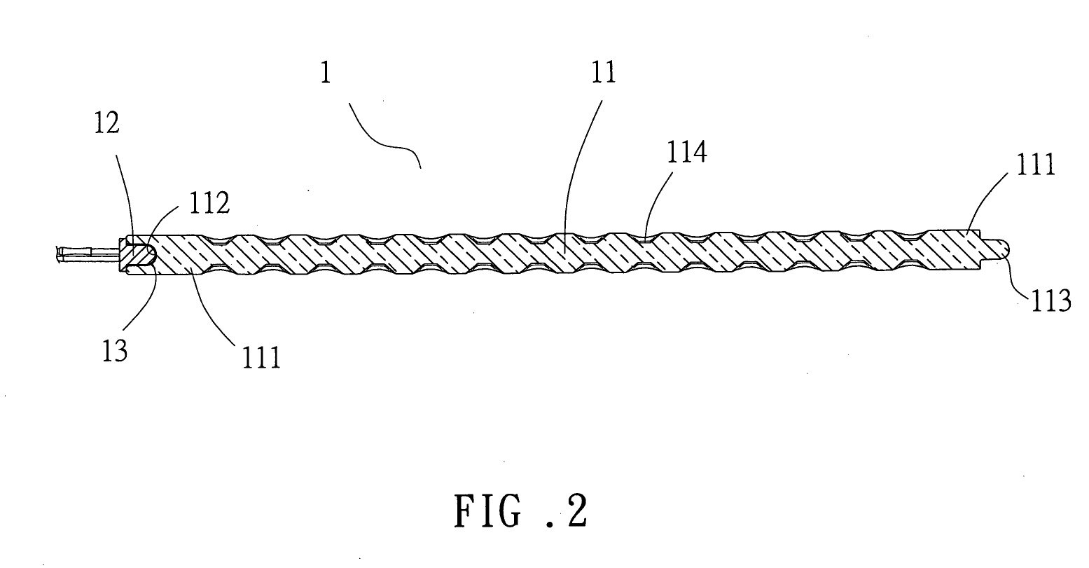

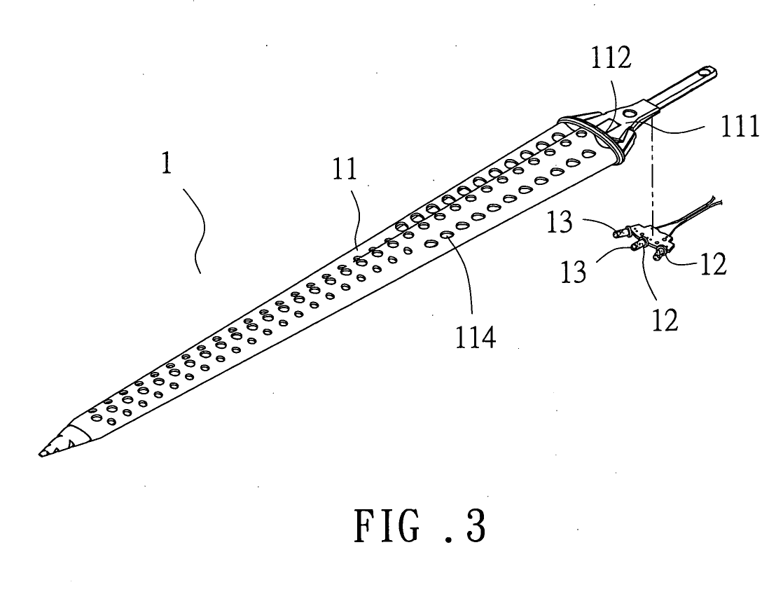

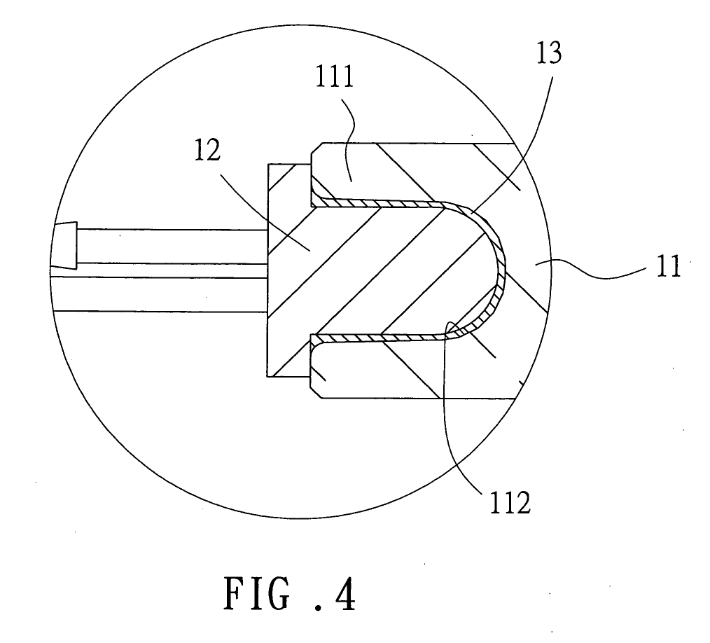

FIG. 2 is a schematic sectional view showing the first embodiment of the present invention. As shown in FIG. 2, the outer surface of the light transmissible stick body (11) is formed with a plurality of recesses (114) arranged in equidistance on the outer surface of the light transmissible stick body (11) by etching or by machining. In turn, a recessed segment (112) in correspondence to the light emitting element (12) is provided at the insertion end (111). The light emitting element (12) coated with optical adhesive (13) on the outer surface is thus inserted into the recessed segment (112). FIG. 3 is a schematic perspective view showing the appearance of the second embodiment of the present invention. As shown in FIG. 3, the light transmissible stick body (11) can be formed into cylindrical tubular shape as shown in FIG. 1, or toy-sword shape as shown in FIG. 3, or stick shape having appearance design. Similarly, the outer surface of the sword shape light transmissible stick body (11) is formed with a plurality of recesses (114) arranged in equidistance on the outer surface of the sword shape light transmissible stick body (11) by etching or by machining. The recessed segment (112) in correspondence to the light emitting element (12) is provided at the insertion end (111). The number of recessed segment (112) can be provided according to the quantities of the light emitting element (12), i.e., for example, two or three recessed segments (112) can be provided at the insertion end (111) of the light transmissible stick body (11) such that two or three light emitting elements (12) coated with optical adhesive (13) on the outer surface are inserted into the respective recessed segments (112). In turn, the light emitting element (12) is a light emitting diode (LED) on the outer surface of which is coated with a layer of optical adhesive (13), usually the optical adhesive (13) being a UV adhesive. After each light emitting element (12) is inserted into corresponding recessed segment (112) at the insertion end (111), the optical adhesive (13) is irradiated with UV light emitted from a UV curing device such that the optical adhesive (13) is cured and closely adhered on the recessed segment (112), as shown in FIG. 4.

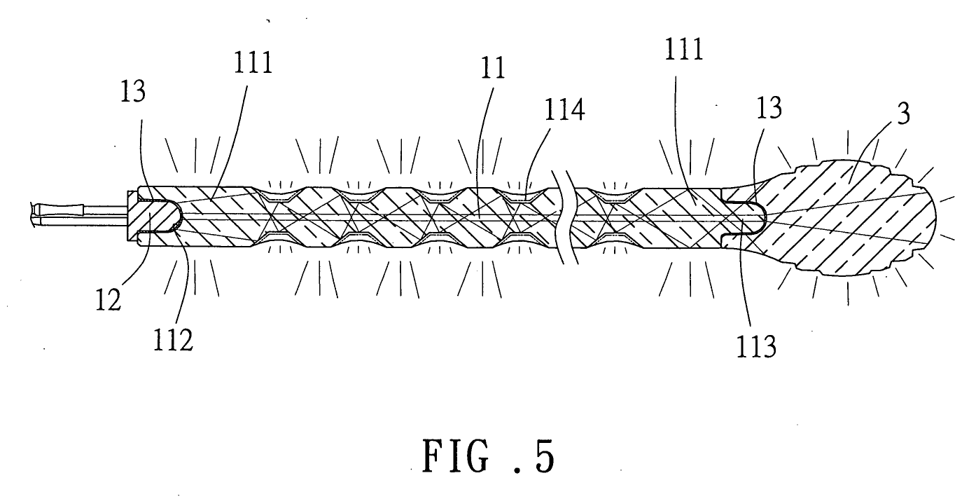

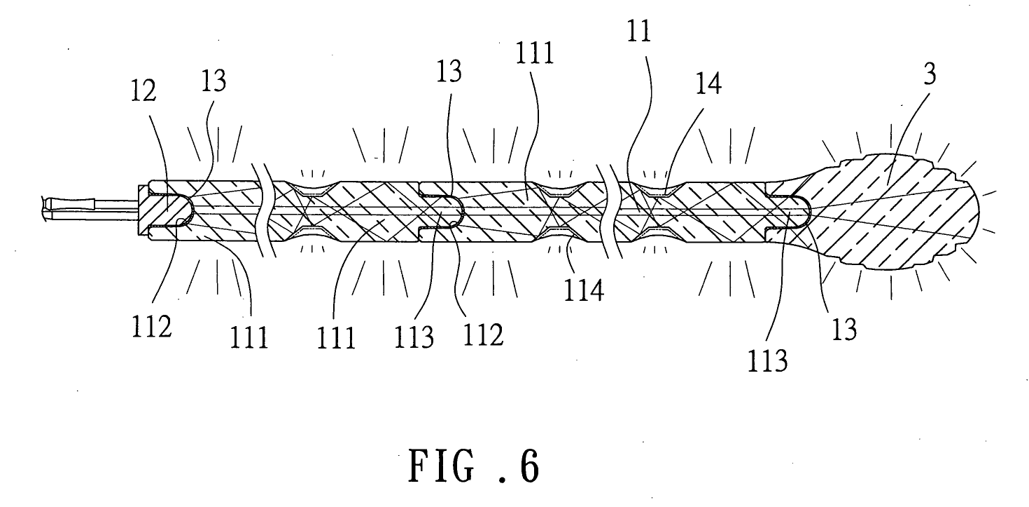

FIG. 5 is a schematic sectional view showing the third embodiment of the present invention. As shown in FIG. 5, the light emitting stick (1) has a light transmissible stick body (11), both ends of the light transmissible stick body (11) being insertion ends (111), one insertion ends (111) being inserted and combined with a light emitting element (12) coated with optical adhesive (13), and the other insertion ends (111) being formed with a protruding segment (113) corresponding to the recessed segment (112). The protruding segment (113) is either combined with a decoration cap (3) with special ornamental design, as shown in FIG. 5, or combined with the insertion ends (111) of another light transmissible stick body (11) after the protruding segment (113) is coated with optical adhesive (13), such that a stretched light emitting stick (1) formed by several light transmissible stick body (11) is obtained, as shown in FIG. 6. In such a manner, when the light emitting element (12) is lightened, the light emitted from the light emitting element (12) is scattered through the optical adhesive (13) without any distortion, and the light conducts reflection through the ragged pattern of the recesses (114) with matte finish. Due to the matte finish conducted on the recessed (114), the light is unable to scatter out through the recesses (114) with matte finish. Thus, the light emitted from the light emitting element (12) can be reserved within the light transmissible stick body (11). Accordingly, the light transmissible stick body (11) itself has brightened performance due to the transmissible property.

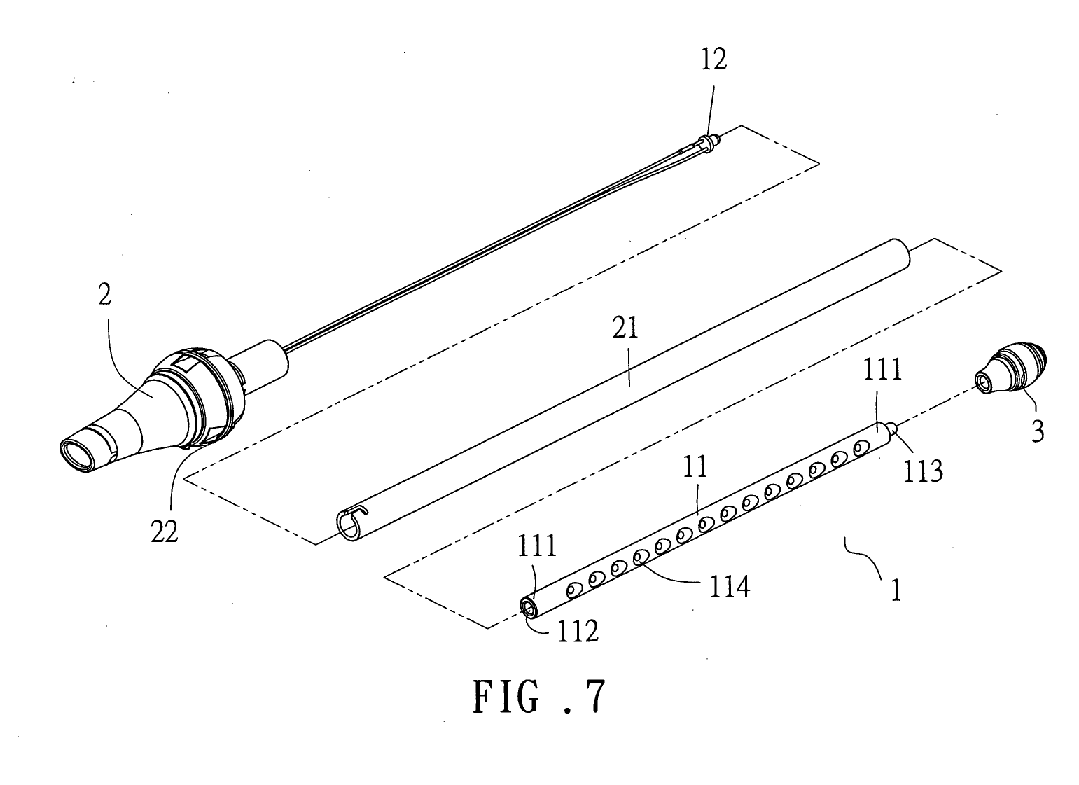

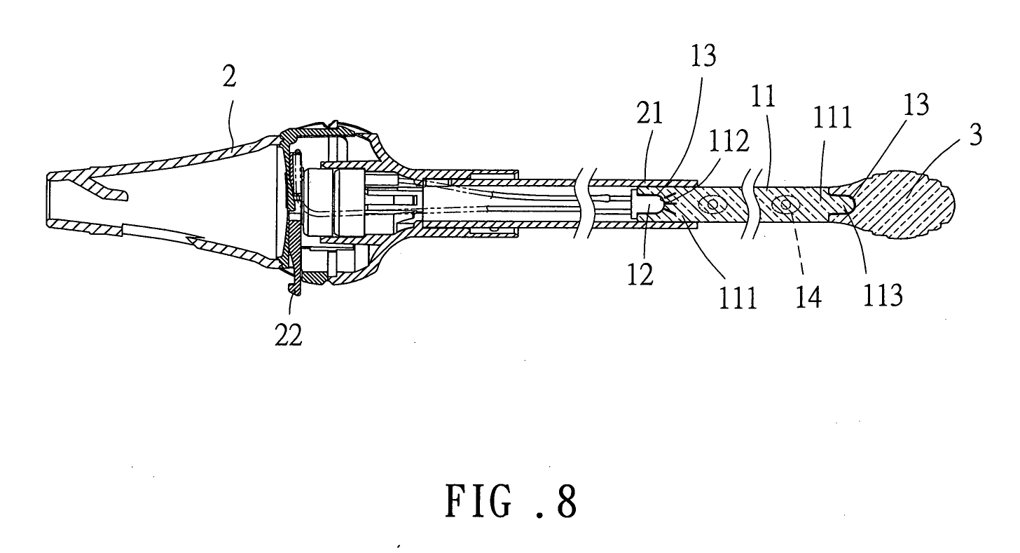

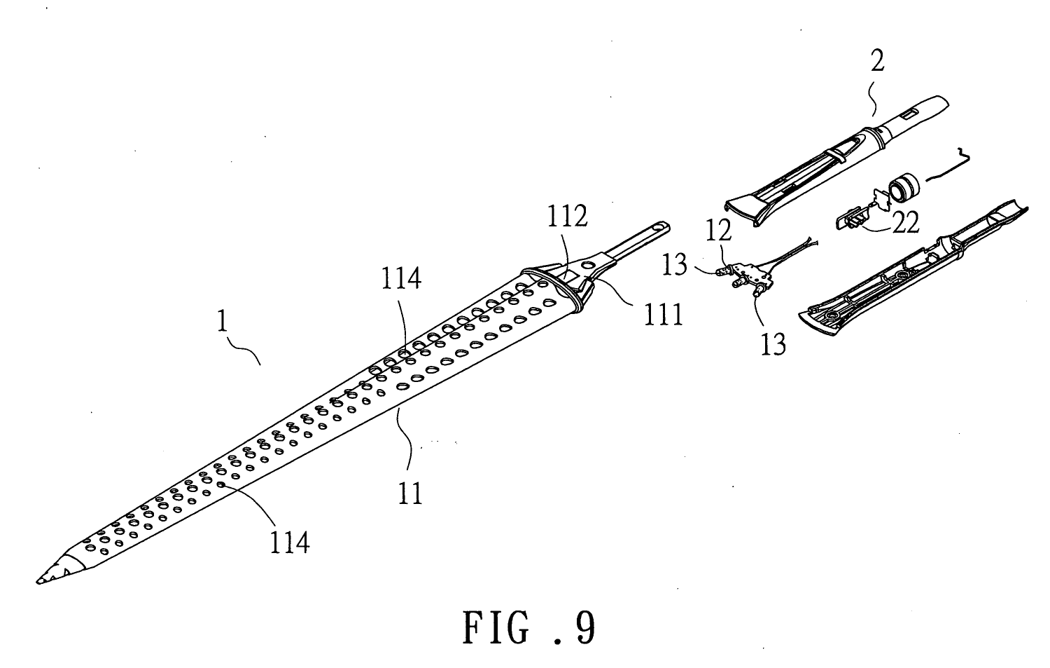

FIGS. 7 and 8 are a schematic perspective exploded and sectional views respectively showing the fifth embodiment of the present invention. As shown in the FIGS. 7 and 8, the light emitting stick (1) is assembled with a handgrip (2). The circuit concerned with the light emitting element (12) is extended into the sleeve (21) of the handgrip (2). A switch (22) is provided on the handgrip (2) to control the ON and OFF of the light emitting element (12). The handgrip (2) can be designed as a whistle which can issue sound. The sword type light transmissible stick body (11) in the second embodiment also can be assembled with a handgrip (2) having a hilt shape. Similarly, a switch (22) can also be provided on the handgrip (2) to control the ON and OFF of the light emitting element (12), and the handgrip (2) can be designed as a whistle which can issue sound. Therefore, the application aspect of the light emitting stick (1) can be diversified, as shown in FIG. 9.

So far, the above-mentioned embodiments and the illustrated Figures are not restrictive to the structure or dimension of the subject matter of this invention. It is noted that persons skilled in the art can ponder out various modifications or variations by referring to the above disclosure. However, any modification or variation conducted without departing from the spirit and scope of this invention are still considered to be within the scope of this invention which is defined by the appended claims.

Based on the foregoing structure and embodiments, the light emitting stick of the present invention has advantages listed as follow when compared to the conventional art:

(1). The light emitting stick of the present invention uses optical adhesive (UV optical adhesive) to combine the light emitting element and the light transmissible stick body such that the light emitted from the light emitting element can be scattered through the optical adhesive without distortion.

(2). The light emitting stick of the present invention adapts the design of recesses having matte finish such that the light emitted from the light emitting element is reflected through the ragged pattern of recesses with matte finish. Due to the matte finish conducted on the recesses, the light is unable to scatter out through the recesses with matte finish. Thus, the light emitted from the light emitting element can be still reserved within the light transmissible stick body. Accordingly, the light transmissible stick body itself has brightened performance due to the transmissible property.

(3). The light emitting stick of the present invention can be assembled with a handgrip or a whistle, and a decoration cap with special ornamental design can be assembled on a protruding segment of the light emitting stick. In this manner, the design of the light emitting stick apparently has diversification of glitz.

(4). The design of the light emitting stick of the present invention, except cylindrical tubular shape, can be any favorite type according to the market demand, such as toy-sword shape, stick shape, gun shape.

1. A light emitting stick, said light emitting stick comprising:
a light transmissible stick body,
one end of said stick body defining an insertion end;
a light emitting element attached to the insertion end by a coating of optical adhesive therebetween, whereby light emitted by the light emitting element is passed through the optical adhesive to the stick body; and
a plurality of recesses with matte finish arranged on the outside surface of said light transmissible stick body by etching.

2. A light emitting stick as claimed in claim 1, wherein said optical adhesive is a UV optical adhesive.

3. A light emitting stick as claimed in claim 1, wherein said light emitting element is a light emitting diode (LED).

4. A light emitting stick as claimed in claim 1, wherein said light transmissible stick body has insertion ends at both ends.

5. A light emitting stick as claimed in claim 4, wherein both insertion ends of said light transmissible stick body are provided with a recessed segment and a protruding segment respectively, said recessed segment is combined with said light emitting element coated with optical adhesive.

6. A light emitting stick as claimed in claim 5, wherein said protruding segment is assembled with a decoration cap.

7. A light emitting stick as claimed in claim 5, wherein said protruding segment is assembled with another light transmissible stick body.

8. A light emitting stick as claimed in claim 1, wherein said light emitting stick is assembled with a handgrip.

9. A light emitting stick as claimed in claim 8, wherein a switch is provided on said handgrip for controlling the ON and OFF of said light emitting element.

10. A light emitting stick as claimed in claim 8, wherein said handgrip is a whistle.
